(19) United States
(12) Patent Application Publication
(10) Pub. No.: US 2020/0317055 A1
(43) Pub. Date: Oct. 8, 2020

(54) AGENT DEVICE, AGENT DEVICE CONTROL METHOD, AND STORAGE MEDIUM

(71) Applicant: HONDA MOTOR CO., LTD., Tokyo (JP)

(72) Inventors: Masaki Kurihara, Wako-shi (JP); Mototsugu Kubota, Wako-shi (JP)

(21) Appl. No.: 16/820,753

(22) Filed: Mar. 17, 2020

(30) Foreign Application Priority Data
Mar. 19, 2019 (JP) 2019-051199

(51) Int. Cl. B60K 35/00; G10L 15/26; B60W 50/10; B60W 60/00

(52) U.S. Cl. CPC B60K 35/00; G10L 15/265; B60W 50/10; B60W 2540/21; B60W 60/0053; B60K 2370/148; B60K 2370/1575; B60W 60/0051

(57) ABSTRACT

An agent device includes a plurality of agent functions configured to provide a service including a response in response to speech of an occupant of a vehicle, wherein a first agent function that is active among the plurality of agent functions is configured to activate another agent function upon receiving an instruction to activate the other agent function.

### CROSS-REFERENCE TO RELATED APPLICATION

Priority is claimed on Japanese Patent Application No. 2019-051199, filed Mar. 19, 2019, the content of which is incorporated herein by reference.

### BACKGROUND

### Field of the Invention

The present invention relates to an agent device, an agent device control method, and a storage medium.

### Description of Related Art

A technology relating to an agent function that provides information on driving support and control of a vehicle in response to a request from an occupant of the vehicle and other applications while dialoguing with the occupant of the vehicle has been disclosed in the related art (for example, Japanese Unexamined Patent Application, First Publication No. 2006-335231).

### SUMMARY

The practical application of mounting a plurality of agent functions on a vehicle has been promoted in recent years. However, it is sometimes difficult to activate an agent while another agent is active. This may impair convenience for an occupant.

Aspects of the present invention have been made in view of such circumstances and it is an object of the present invention to provide an agent device, an agent device control method, and a storage medium that can improve convenience for an occupant.

An agent device, an agent device control method, and a storage medium according to the present invention employ the following configurations.

(1) An agent device according to an aspect of the present invention includes a plurality of agent functions configured to provide a service including a response in response to speech of an occupant of a vehicle, wherein a first agent function that is active among the plurality of agent functions is configured to activate another agent function upon receiving an instruction to activate the other agent function.

(2) In the above aspect (1), the first agent function is configured to activate the other agent function and stop the first agent function upon receiving an instruction to activate the other agent function while the first agent function is active.

(3) In the above aspect (1), the first agent function is configured to activate the other agent function and give the other agent function priority for responding to the speech of the occupant upon receiving an instruction to activate the other agent function while the first agent function is active.

(4) In the above aspect (2), a part of the plurality of agent functions is set as an agent function capable of activating the other agent function.

(5) In the above aspect (4), the part of the plurality of agent functions includes an agent function configured to control the vehicle.

(6) In the above aspect (1), the agent device further includes an activation controller configured to control activation of each of the plurality of agent functions, wherein the activation controller is configured to stop the first agent function upon receiving an instruction to activate the other agent function.

(7) In the above aspect (6), the activation controller is configured to output an end word for ending the first agent function that is active.

(8) An agent device control method according to another aspect of the present invention includes a computer activating some of a plurality of agent functions, providing a service including a response in response to speech of an occupant of a vehicle through a function of the activated agent function, and causing a first agent function that is active among the plurality of agent functions to activate another agent function upon receiving an instruction to activate the other agent function.

(9) A storage medium according to another aspect of the present invention is a non-transitory computer-readable storage medium storing a program causing a computer to activate some of a plurality of agent functions, provide a service including a response in response to speech of an occupant of a vehicle through a function of the activated agent function, and cause a first agent function that is active among the plurality of agent functions to activate another agent function upon receiving an instruction to activate the other agent function.

According to the above aspects (1) to (9), it is possible to improve convenience for an occupant.

### BRIEF DESCRIPTION OF THE DRAWINGS

FIG. 1 is a configuration diagram of an agent system including an agent device.

FIG. 2 is a diagram showing a configuration of an agent device according to a first embodiment and devices mounted in a vehicle.

FIG. 3 is a diagram showing an example of an arrangement of a display/operation device and a speaker unit.

FIG. 4 is a diagram showing an example of the content of agent control information.

FIG. 5 is a diagram showing a configuration of an agent server according to the first embodiment and a part of the configuration of the agent device.

FIG. 6 is a diagram showing an example of an image displayed by a display controller in a situation where no agents are active.

FIG. 7 is a diagram showing an example of an image displayed by the display controller in a situation where a first agent function is active.

FIG. 8 is a diagram showing an example of how a response result is output.

FIG. 9 is a diagram illustrating how another agent function outputs a response result.

FIG. 10 is a diagram illustrating information output when the priority for responding has been shifted.

FIG. 11 is a flowchart illustrating an example of a flow of processing performed by the agent device according to the first embodiment.

FIG. 12 is a diagram showing a configuration of an agent device according to a second embodiment and devices mounted in a vehicle.

FIG. 13 is a flowchart illustrating an example of a flow of processing performed by the agent device according to the second embodiment.

### DESCRIPTION OF EMBODIMENTS

Hereinafter, embodiments of an agent device, an agent device control method, and a storage medium of the present invention will be described with reference to the drawings. The agent device is a device that realizes all or a part of an agent system. Hereinafter, an agent device that is mounted in a vehicle (hereinafter referred to as a vehicle M) and has a plurality of types of agent functions will be described as an example of the agent device. An agent function is, for example, a function of providing various types of information based on a request (command) included in speech of the occupant or mediating network services while dialoguing with an occupant of the vehicle M. The functions, processing procedures, controls, and output modes/contents of the plurality of types of agent functions may be different from each other. Some of the agent functions may have a function of controlling equipment in the vehicle (for example, equipment related to driving control and vehicle body control).

The agent functions are realized, for example, by integrally using a natural language processing function (a function of understanding the structure and meaning of text), a dialogue management function, a network search function of searching other devices via a network or searching a predetermined database included in the agent device, and the like in addition to a voice recognition function of recognizing an occupant's voice (a function of converting a voice into text). Some or all of these functions may be realized by artificial intelligence (AI) technology. A part of a configuration for performing these functions (particularly, the voice recognition function and the natural language processing/analysis function) may be mounted in an agent server (an external device) that can communicate with a vehicle-mounted communication device of the vehicle M or with a general-purpose communication device that has been brought into the vehicle M. In the following description, it is assumed that a part of the configuration is mounted in the agent server and the agent device and the agent server cooperate to realize an agent system. A service providing entity (service entity) that is caused to appear by an agent device and an agent server in cooperation is referred to as an agent.

### <Overall Configuration>

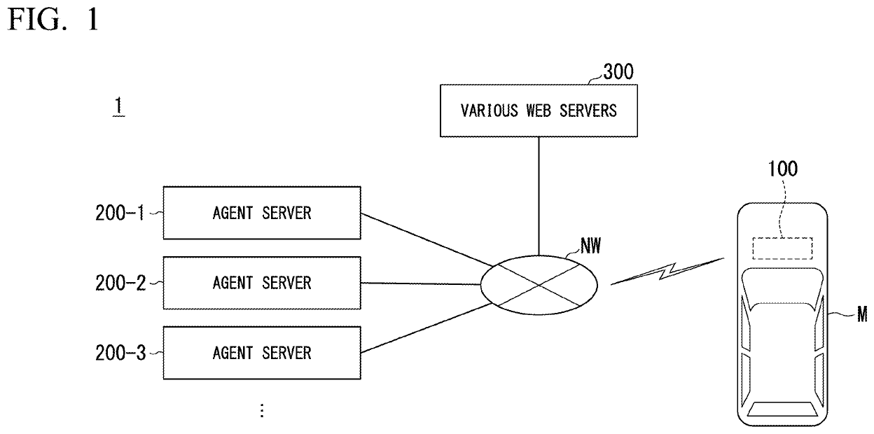

FIG. 1 is a configuration diagram of an agent system 1 including an agent device 100. The agent system 1 includes, for example, the agent device 100 and a plurality of agent servers 200-1, 200-2, 200-3, . . . . A number following the hyphen at the end of a reference sign is an identifier identifying an agent. The agent servers may be simply referred to as agent servers 200 when they are not distinguished from each other. Although three agent servers 200 are shown in FIG. 1, the number of agent servers 200 may be two or four or more. The agent servers 200 are operated, for example, by different agent system providers. Thus, agents in the present embodiment are realized by different providers. Examples of the providers include an automobile manufacturer, a network service provider, an e-commerce provider, and a mobile terminal seller and manufacturer. Arbitrary entities (such as corporations, organizations, or individuals) may be agent system providers.

The agent device 100 communicates with each agent server 200 via a network NW. The network NW includes, for example, some or all of the Internet, a cellular network, a Wi-Fi network, a wide area network (WAN), a local area network (LAN), a public line, a telephone line, a wireless base station, and the like. Various web servers 300 are connected to the network NW and the agent server 200 or the agent device 100 can acquire various information from the various web servers 300 via the network NW through a web page or a web application programming interface (API).

The agent device 100 dialogues with an occupant of the vehicle M, transmits a voice from the occupant to an agent server 200, and presents a reply obtained from the agent server 200 to the occupant in the form of voice output or image display. The agent device 100 controls the vehicle equipment 50 on the basis of a request from the occupant.

### First Embodiment

### [Vehicle]

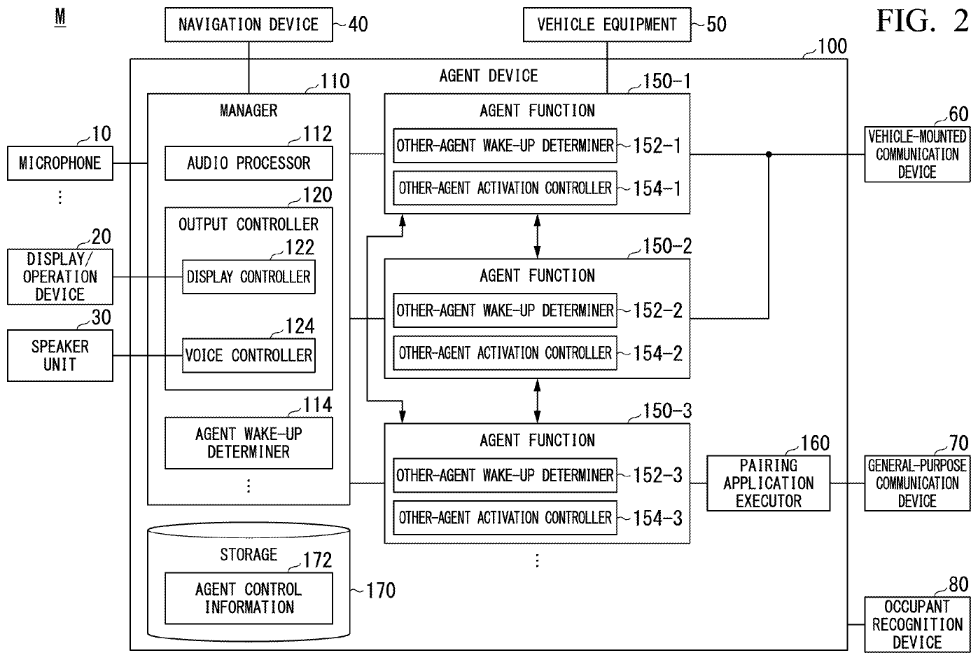

FIG. 2 is a diagram showing a configuration of an agent device 100 according to a first embodiment and devices mounted in a vehicle M. For example, one or more microphones 10, a display/operation device 20, a speaker unit 30, a navigation device 40, vehicle equipment 50, a vehicle-mounted communication device 60, an occupant recognition device 80, and the agent device 100 are mounted in the vehicle M. A general-purpose communication device 70 such as a smartphone may sometimes be brought into an occupant compartment and used as a communication device. These devices are connected to each other through a multiplex communication line such as a controller area network (CAN) communication line, a serial communication line, or a wireless communication network. The components shown in FIG. 2 are merely examples and some of the components may be omitted or other components may be added. A combination of the display/operation device 20 and the speaker unit 30 is an example of an “output.”

Each of the microphones 10 is a sound collector that collects sounds generated in the occupant compartment. The display/operation device 20 is a device (or a device group) that can display an image and receive an input operation. The display/operation device 20 includes, for example, a display device configured as a touch panel. The display/operation device 20 may further include a head-up display (HUD) or a mechanical input device. The speaker unit 30 includes, for example, a plurality of speakers (sound outputs) arranged at different positions in the occupant compartment. The display/operation device 20 and the speaker unit 30 may be shared by the agent device 100 and the navigation device 40. Details of these components will be described later.

The navigation device 40 includes a navigation human machine interface (HMI), a positioning device such as a global positioning system (GPS), a storage device that stores map information, and a control device (a navigation controller) that performs route search and the like. Some or all of the microphones 10, the display/operation device 20, and the speaker unit 30 may be used as a navigation HMI. The navigation device 40 searches for a route (navigation route) for moving from a position of the vehicle M identified by the positioning device to a destination input by the occupant and outputs guidance information using the navigation HMI such that the vehicle M can travel along the route. The route search function may be provided in a navigation server that can be accessed via the network NW. In this case, the navigation device 40 acquires a route from the navigation server and outputs guidance information. The agent device 100 may be constructed based on a navigation controller. In this case, the navigation controller and the agent device 100 are configured integrally in hardware.

The vehicle equipment 50 is, for example, equipment mounted in the vehicle M. The vehicle equipment 50 includes, for example, a driving force output device such as an engine or a drive motor, an engine starting motor, door lock devices, door opening/closing devices, windows, window opening/closing devices, a window opening/closing control device, seats, a seat position control device, rearview mirrors and an angular position control device thereof, lighting devices inside and outside the vehicle and a control device thereof, wipers and defoggers and respective control devices thereof, direction indicators and a control device thereof, an air conditioner, and vehicle information devices such as those of mileage, tire pressure information, and remaining fuel amount information.

The vehicle-mounted communication device 60 is, for example, a wireless communication device capable of accessing the network NW by using a cellular network or a Wi-Fi network.

The occupant recognition device 80 includes, for example, seat sensors, a vehicle interior camera, and an image recognition device. The seat sensors include pressure sensors provided below seats and tension sensors attached to seat belts. The vehicle interior camera is a charge coupled device (CCD) camera or a complementary metal oxide semiconductor (CMOS) camera provided in the occupant compartment. The image recognition device analyzes an image from the vehicle interior camera and recognizes the presence or absence of an occupant in each seat, a face orientation of the occupant, and the like.

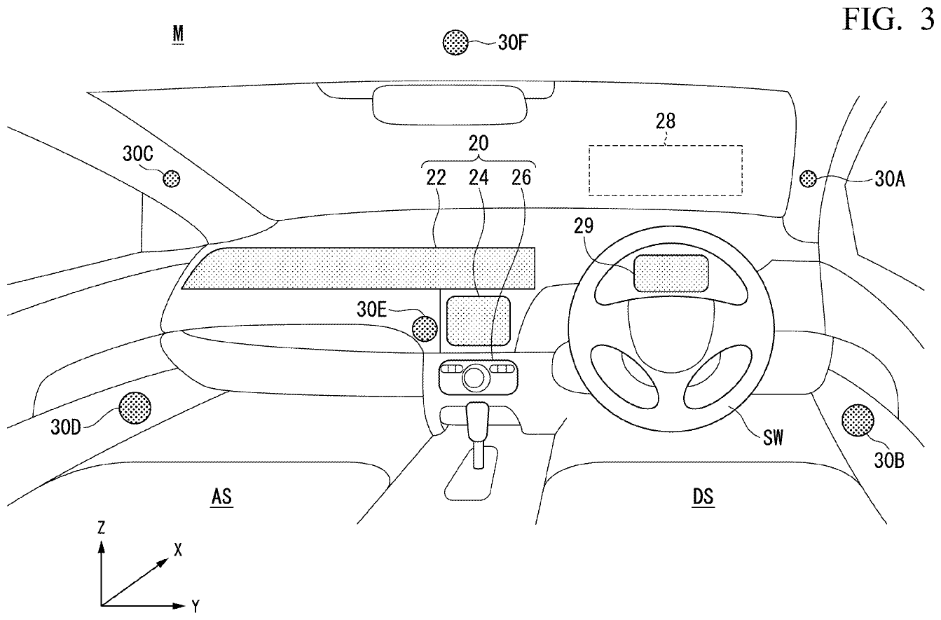

FIG. 3 is a diagram showing an example of the arrangement of the display/operation device 20 and the speaker unit 30. The display/operation device 20 includes, for example, a first display 22, a second display 24, and an operation switch assembly 26. The display/operation device 20 may further include an HUD 28. The display/operation device 20 may further include a meter display 29 provided at a portion on an instrument panel facing a driver's seat DS. A combination of the first display 22, the second display 24, the HUD 28, and the meter display 29 is an example of a “display.”

The vehicle M has, for example, a driver's seat DS, where a steering wheel SW is provided, and a passenger's seat AS which is provided lateral to the driver's seat DS in the vehicle width direction (Y direction in the drawing). The first display 22 is a horizontally long display device that extends on the instrument panel from near the midpoint between the driver's seat DS and the passenger's seat AS to a position facing a left end of the passenger's seat AS. The second display 24 is provided below the first display at an intermediate position in the vehicle width direction between the driver's seat DS and the passenger's seat AS. For example, each of the first display 22 and the second display 24 is configured as a touch panel and includes a liquid crystal display (LCD), an organic electroluminescence (EL), a plasma display, or the like as a display. The operation switch assembly 26 is an assembly of a dial switch, button switches, and the like. The HUD 28 is, for example, a device that allows an image to be viewed superimposed on a landscape. For example, the HUD 28 projects light including an image on a front windshield or a combiner of the vehicle M to allow an occupant to view a virtual image. The meter display 29 is, for example, an LCD or an organic EL and displays meters such as a speedometer and a tachometer. The display/operation device 20 outputs the content of an operation performed by the occupant to the agent device 100. The content displayed by each display described above may be determined by the agent device 100.

The speaker unit 30 includes, for example, speakers 30A to 30F. The speaker 30A is installed on a window post (a so-called A pillar) on the driver's seat DS side. The speaker 30B is installed at a lower portion on a door near the driver's seat DS. The speaker 30C is installed on a window post on the passenger's seat AS side. The speaker 30D is installed at a lower portion on a door near the passenger's seat AS. The speaker 30E is installed near the second display 24. The speaker 30F is installed on the ceiling (roof) of the occupant compartment. The speaker unit 30 may also be installed at a lower portion on a door near a right rear seat or a left rear seat.

For example, causing only the speakers 30A and 30B in such an arrangement to output a sound localizes a sound image near the driver's seat DS. “Localizing a sound image” means, for example, determining the spatial position of a sound source sensed by the occupant by adjusting the volumes of sounds transmitted to the left and right ears of the occupant. Causing only the speakers 30C and 30D to output a sound localizes a sound image near the passenger's seat AS. Causing only the speaker 30E to output a sound localizes a sound image near the front of the occupant compartment, and causing only the speaker 30F to output a sound localizes a sound image near an upper portion in the occupant compartment. The present invention is not limited to this and the speaker unit 30 can localize a sound image at an arbitrary position in the occupant compartment by adjusting the distribution of sounds output from the speakers using a mixer or an amplifier.

### [Agent Device]

Returning to FIG. 2, the agent device 100 includes a manager 110, agent functions 150-1, 150-2, and 150-3, a pairing application executor 160, and a storage 170. The manager 110 includes, for example, an audio processor 112, agent wake-up (WU) determiners 114, and an output controller 120. Hereinafter, the agent functions are simply referred to as agent functions 150 when they are not distinguished from each other. The three agent functions 150 shown are merely an example corresponding to the number of agent servers 200 of FIG. 1 and the number of agent functions 150 may be two or four or more. The software arrangement of FIG. 2 is simply shown for ease of explanation and may actually be modified arbitrarily such that, for example, the manager 110 is interposed between the agent functions 150 and the vehicle-mounted communication device 60. In the following description, an agent that is caused to appear by the agent function 150-1 and the agent server 200-1 in cooperation may sometimes be referred to as agent 1, an agent that is caused to appear by the agent function 150-2 and the agent server 200-2 in cooperation may sometimes be referred to as agent 2, and an agent that is caused to appear by the agent function 150-3 and the agent server 200-3 in cooperation may sometimes be referred to as agent 3.

Each component of the agent device 100 is realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by software and hardware in cooperation. The program may be stored in a storage device (a storage device having a non-transitory storage medium) such as a hard disk drive (HDD) or a flash memory in advance or may be stored in a detachable storage medium (non-transitory storage medium) such as a DVD or a CD-ROM and then installed by mounting the storage medium in a drive device.

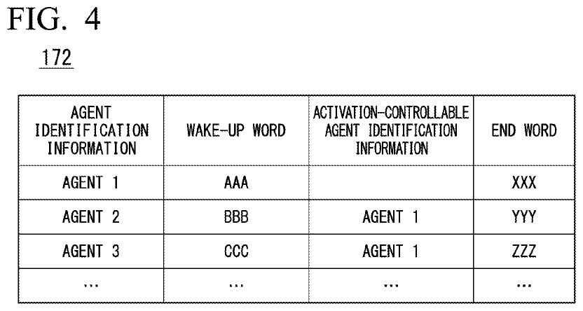

The storage 170 is realized by the various storage devices described above. The storage 170 stores, for example, data such as agent control information 172 and programs. FIG. 4 is a diagram showing an example of the content of the agent control information 172. In the agent control information 172, for example, a wake-up word (activation word), activation-controllable agent identification information, and an end word are associated with agent identification information identifying an agent. For example, a word or a phrase for activating an agent function corresponding to each agent is stored as the wake-up word. For example, identification information of an agent having the authority to activate an agent indicated by the wake-up word is stored as the activation-controllable agent identification information. The example of FIG. 4 shows that the agent 1 can activate the agents 2 and 3 and the agents 2 and 3 cannot activate other agents. For example, a word or a phrase for ending the agent is stored as the end word. The agent control information 172 is updated appropriately, for example, by the manager 110 or the agent server 200.

The manager 110 functions through execution of a program such as an operating system (OS) or middleware.

The audio processor 112 of the manager 110 receives a voice collected through a microphone 10 and performs audio processing on the received voice to bring it into a state suitable for recognizing a wake-up word that has been set in advance for each agent. The audio processing is, for example, noise removal based on filtering of a band-pass filter or the like or amplification of the sound. The audio processor 112 outputs a voice subjected to the audio processing to the agent wake-up determiners 114 or an active agent function.

The agent wake-up determiners 114 are provided corresponding respectively to the agent functions 150-1, 150-2, and 150-3 and each recognize a wake-up word predetermined for a corresponding agent while a corresponding agent function is not active. Each agent wake-up determiner 114 recognizes the meaning of the voice (voice stream) from the voice subjected to the audio processing. First, the agent wake-up determiner 114 detects a voice section on the basis of the amplitude and the zero crossing of voice waves in the voice stream. The agent wake-up determiner 114 may perform section detection based on voice identification and non-voice identification in units of frames based on a Gaussian mixture model (GMM).

Next, the agent wake-up determiner 114 converts the voice in the detected voice section into text and sets the text as text information. Then, the agent wake-up determiner 114 compares the text information obtained through the conversion into text with wake-up words in the agent control information 172 stored in the storage 170 and determines whether or not the text information corresponds to any of the wake-up words included in the agent control information 172. Upon determining that the text information is a wake-up word, the agent wake-up determiner 114 activates a corresponding agent function 150. A function corresponding to the agent wake-up determiner 114 may be installed in the agent server 200. In this case, the manager 110 transmits the voice stream subjected to the audio processing of the audio processor 112 to the agent server 200, and activates the agent function 150 in accordance with an instruction from the agent server 200 when the agent server 200 has determined that the text information is a wake-up word. Each of the agent functions 150 may always be active and perform wake-up word determination by itself. In this case, the manager 110 does not need to include the agent wake-up determiners 114.

The agent wake-up determiner 114 stops (ends) an active agent function when an end word included in the spoken voice has been recognized through a procedure similar to that described above and an agent corresponding to the end word is in an active state (hereinafter referred to as “active” as necessary). The agent wake-up determiner 114 may stop the active agent when an input of a voice has not been received for a predetermined time or more or when a predetermined instruction operation for ending the agent has been received.

The output controller 120 causes the display or the speaker unit 30 to output information such as a response result in response to an instruction from the manager 110 or an agent function 150 to provide a service or the like to the occupant. The output controller 120 includes, for example, a display controller 122 and a voice controller 124.

The display controller 122 causes an image to be displayed on the display in at least a partial area thereof in accordance with an instruction from the output controller 120. The following description will be given assuming that an image relating to an agent is displayed on the first display 22. Under the control of the output controller 120, the display controller 122 generates, for example, an anthropomorphic agent image (hereinafter referred to as an agent image) that communicates with an occupant in the occupant compartment and causes the first display 22 to display the generated agent image. The agent image is, for example, an image in a mode of talking to the occupant. The agent image may include, for example, a facial image that at least enables the viewer (occupant) to recognize its facial expression and face orientation. The agent image may be, for example, an image in which parts resembling eyes and a nose are represented in its face area and which allows the facial expression and the face orientation to be recognized on the basis of the positions of the parts in the face area. The agent image may also be an image that the viewer perceives as three dimensional and includes a head image in a three-dimensional space such that the face orientation of the agent is recognized by the viewer or includes an image of a body (torso and limbs) such that the motion or behavior, posture, and the like of the agent are recognized by the viewer. The agent image may be an animation image. For example, the display controller 122 may cause the agent image to be displayed in a display area close to the position of the occupant recognized by the occupant recognition device 80 or may generate an agent image with a face directed to the position of the occupant and cause the generated agent image to be displayed.

The voice controller 124 causes some or all of the speakers included in the speaker unit 30 to output a voice in accordance with an instruction from the output controller 120. The voice controller 124 may perform control to localize a sound image of an agent voice at a position corresponding to the display position of the agent image by using the plurality speakers of the speaker unit 30. The position corresponding to the display position of the agent image is, for example, a position where the occupant is expected to perceive the agent image speaking the agent voice, specifically, a position near the display position of the agent image (for example, within 2 to 3 cm from the display position).

Each of the agent functions 150 causes an agent to appear in cooperation with a corresponding agent server 200 and provides a service including causing the output to output a voice response in response to speech of an occupant of the vehicle. The agent functions 150 may include an agent function 150 to which authority to control the vehicle M (for example, the vehicle equipment 50) is assigned. Some of the agent functions 150 may be linked to the general-purpose communication device 70 via the pairing application executor 160 to communicate with an agent server 200. For example, the authority to control the vehicle M (for example, the vehicle equipment 50) is assigned to the agent function 150-1. The agent function 150-1 communicates with the agent server 200-1 via the vehicle-mounted communication device 60. The agent function 150-2 communicates with the agent server 200-2 via the vehicle-mounted communication device 60. The agent function 150-3 is linked to the general-purpose communication device 70 via the pairing application executor 160 to communicate with the agent server 200-3.

The pairing application executor 160 performs pairing with the general-purpose communication device 70, for example, using Bluetooth (registered trademark) such that the agent function 150-3 and the general-purpose communication device 70 are connected. The agent function 150-3 may be connected to the general-purpose communication device 70 through wired communication using a universal serial bus (USB) or the like.

Each of the agent functions 150-1 to 150-3 executes processing on speech (voice) of the occupant input from the audio processor 112 or the like and outputs an execution result (for example, a response result to a request included in the speech) to the manager 110. Each of the agent functions 150-1 to 150-3 includes, for example, an other-agent wake-up determiner 152 and an other-agent activation controller 154. In the first embodiment, the other-agent activation controller 154 is an example of an “activation controller.”

The other-agent wake-up determiner 152 determines, for example, whether or not a wake-up word for activating an agent function agent (hereinafter referred to as another agent function) corresponding to an agent other than its own agent (hereinafter referred to as another agent) is included in a voice obtained from the audio processor 112 while its own agent is active. In this case, similar to the agent wake-up determiner 114, the other agent wake-up determiner 152 recognizes the meaning of the voice subjected to the audio processing and compares text information obtained through conversion of the voice into text with wake-up words in the agent control information 172 and determines whether or not the text information corresponds to any of the wake-up words of the other agents included in the agent control information 172.

The other-agent activation controller 154 activates a corresponding agent function upon determining from the determination result of the other-agent wake-up determiner 152 that there is a wake-up word for another agent. Functions corresponding to the other-agent wake-up determiner 152 and the other-agent activation controller 154 may be mounted in the agent server 200. Details of the functions of the agent function 150 will be described later.

### [Agent Server]

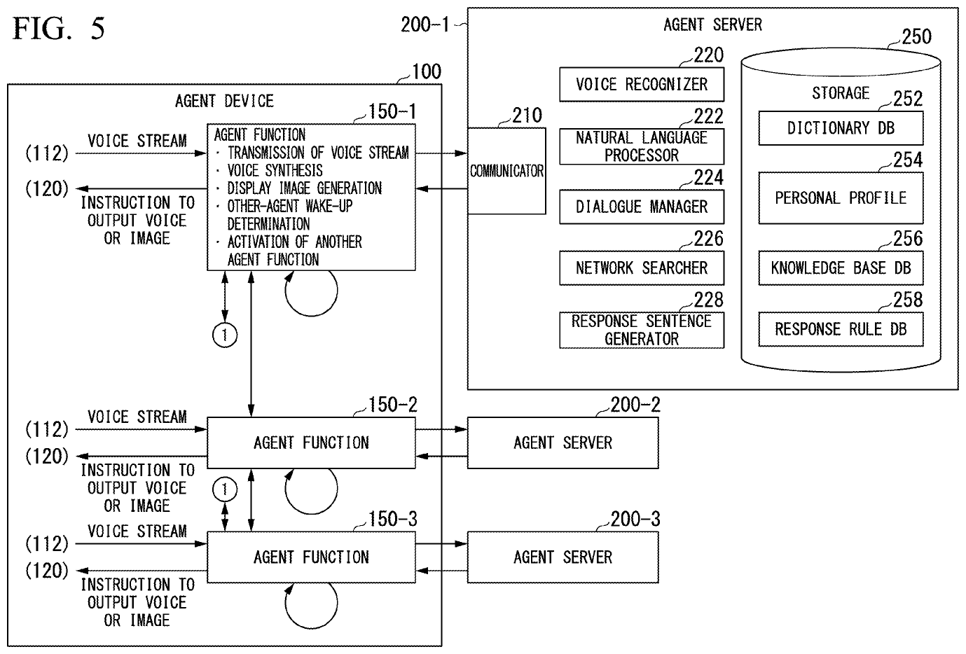

FIG. 5 is a diagram showing a configuration of an agent server 200 according to the first embodiment and a part of the configuration of the agent device 100. Hereinafter, the operations of the agent functions 150 and the like will be described together with the configuration of the agent servers 200. Here, a description of physical communication from the agent device 100 to the network NW is omitted. The following description will focus mainly on the agent function 150-1 and the agent server 200-1. However, the other sets of agent functions and agent servers perform almost the same operations with some differences in detailed functions, databases, and the like.

The agent server 200-1 includes a communicator 210. The communicator 210 is, for example, a network interface such as a network interface card (NIC). The agent server 200-1 further includes, for example, a voice recognizer 220, a natural language processor 222, a dialogue manager 224, a network searcher 226, a response sentence generator 228, and a storage 250. Each of these components is realized, for example, by a hardware processor such as a CPU executing a program (software). Some or all of these components may be realized by hardware (including circuitry) such as LSI, an ASIC, an FPGA, or a GPU or may be realized by software and hardware in cooperation. The program may be stored in a storage device (a storage device having a non-transitory storage medium) such as an HDD or a flash memory in advance or may be stored in a detachable storage medium (non-transitory storage medium) such as a DVD or a CD-ROM and then installed by mounting the storage medium in a drive device. A combination of the voice recognizer 220 and the natural language processor 222 is an example of a “recognizer.”

The storage 250 is realized by the various storage devices described above. The storage 250 stores, for example, programs and data such as a dictionary database (DB) 252, a personal profile 254, a knowledge base database 256, and a response rule database 258.

In the agent device 100, the agent function 150-1 transmits, for example, a voice stream input from the audio processor 112 or the like or a voice stream subjected to processing such as compression or encoding to the agent server 200-1. If the agent function 150-1 can recognize a command (request content) that can be processed locally (without involving the agent server 200-1), the agent function 150-1 may execute processing requested by the command. The command that can be processed locally is, for example, a command that can be responded to by referring to the storage 170 included in the agent device 100. More specifically, the command that can be processed locally is, for example, a command to search for the name of a specific person from telephone directory data present in the storage 170 and call a telephone number associated with the found name (call the other party). Thus, the agent function 150-1 may have some of the functions of the agent server 200-1.

When a voice stream has been acquired, the voice recognizer 220 performs voice recognition to convert it into text information and outputs the text information and the natural language processor 222 performs semantic interpretation on the text information with reference to the dictionary database 252. The dictionary database 252 is, for example, a dictionary database in which abstracted semantic information is associated with text information. The dictionary database 252 may include list information of synonyms and similar words. Processing steps of the voice recognizer 220 and processing steps of the natural language processor 222 may not be clearly separated, but may affect each other such that, for example, the voice recognizer 220 receives a processing result of the natural language processor 222 and corrects a recognition result using the received processing result.

For example, when text such as “Today's weather” or “How is the weather” has been recognized as a voice recognition result, the natural language processor 222 generates an internal state in which the user intention has been replaced with “weather: today.” This makes it easy to perform the requested dialogue even if the voice of the request contains some text variations or wording differences. The natural language processor 222 may recognize the meaning of the text information or may generate a command based on the recognition result, for example, using artificial intelligence processing such as machine learning processing based on probability.

The dialogue manager 224 determines the content of a response to the occupant of the vehicle M (for example, the content of speech to the occupant or an image or voice to be output through the output) by referring to the personal profile 254, the knowledge base database 256, and the response rule database 258 on the basis of the input command. The personal profile 254 includes personal information of the occupant, hobbies and preferences, a past conversation history, and the like stored for each occupant. The knowledge base database 256 is information that defines relations between things. The response rule database 258 is information that defines operations (replies, details of equipment control, or the like) that the agent is to perform in response to commands.

The dialogue manager 224 may identify the occupant by performing comparison with the personal profile 254 using feature information obtained from the voice stream. In this case, for example, personal information has been associated with voice feature information in the personal profile 254. The feature information of the voice is, for example, information on speech features such as the pitch, intonation, and rhythm (sound pitch pattern) of voice or information on feature amounts based on Mel frequency cepstrum coefficients or the like. The feature information of the voice is, for example, information obtained by having the occupant speak a predetermined word, sentence, or the like and recognizing the spoken voice at the time of initial registration of the occupant.

If the command requests information that can be searched for via the network NW, the dialogue manager 224 causes the network searcher 226 to perform searching. The network searcher 226 accesses the various web servers 300 via the network NW and acquires desired information. The “information that can be searched for via the network NW” is, for example, evaluation results of general users on restaurants near the vehicle M or a weather forecast according to the position of the vehicle M on that day.

The response sentence generator 228 generates a response sentence such that the content of the speech determined by the dialogue manager 224 is communicated to the occupant of the vehicle M and transmits the generated response sentence (response result) to the agent device 100. The response sentence generator 228 may acquire a recognition result of the occupant recognition device 80 from the agent device 100 and, upon identifying from the acquired recognition result that the occupant who voiced the speech containing a command is an occupant registered in the personal profile 254, generate a response sentence calling the name of the occupant or having a speaking style suited to the speaking style of the occupant.

Upon acquiring the response sentence, the agent function 150 instructs the voice controller 124 to perform voice synthesis and output a voice. The agent function 150 generates an agent image in accordance with the voice output and instructs the display controller 122 to display the generated agent image, an image included in the response result, and the like. This realizes an agent function which causes a virtually appearing agent to respond to the occupant of the vehicle M. While active, the agent function 150 determines whether or not a wake-up word for another agent is included in an input voice stream and performs control to activate another agent function or the like.

### [Functions of Agent Functions]

Hereinafter, details of the functions of the agent functions 150 will be specifically described. The following description will focus mainly on a function of each agent function 150 relating to activation control of another agent function and a response result that is output by the output controller 120 through a function of the agent function 150 and then provided to an occupant (hereinafter referred to as an occupant P). A method of activating an agent by a wake-up word included in a voice will be described below. However, the method of activating an agent is not limited to this. For example, an agent may be activated by operating a start button (an operator) already provided in the vehicle. Hereinafter, it is assumed that an image is displayed on the first display 22 when it is displayed by the display controller 122. An agent function that is activated first with none of the agent functions 150 being active will hereinafter be referred to as a “first agent function.”

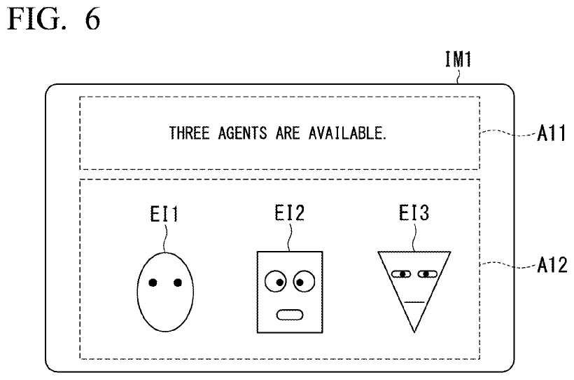

FIG. 6 is a diagram showing an example of an image IM1 displayed by the display controller 122 in a situation where no agents are active. Content, a layout, and the like displayed on the image IM1 are not limited to those of this example. The display controller 122 generates the image IM1 on the basis of an instruction from the output controller 120 or the like. The same applies to the following description of images.

For example, when the occupant P does not dialog with any agent (i.e., in a state where the first agent function is absent), the output controller 120 causes the display controller 122 to generate the image IM1 as an initial state screen and causes the first display 22 to display the generated image IM1.

The image IM1 includes, for example, a text information display area A11 and an agent display area A12. For example, information on the number and types of available agents is displayed in the text information display area A11. The available agents are, for example, agents that can be activated by the occupant, and more specifically, agents that can respond to the occupant's speech. The available agents are set, for example, on the basis of the area in which the vehicle M is traveling, the time zone when it is traveling, the states of the agents, and an occupant P recognized by the occupant recognition device 80. The states of the agents include, for example, a state in which communication with the agent servers 200 are not possible because the vehicle M is underground or in a tunnel or a state in which processing by another command is already being executed and thus processing for the next speech cannot be executed. In the example of FIG. 6, text information “Three agents are available” is displayed in the text information display area A11.

For example, agent images associated with the available agents are displayed in the agent display area A12. In the example of FIG. 6, agent images EI1 to EI3 associated with the agent functions 150-1 to 150-3 are displayed in the agent display area A12. This allows the occupant P to easily identify the number and types of available agents.

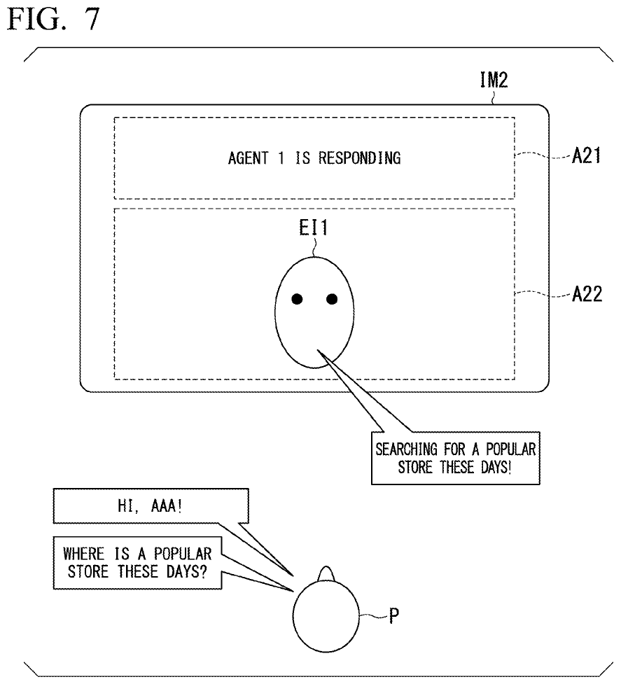

Here, an agent wake-up determiner 114 recognizes a wake-up word included in the speech of the occupant P and activates a first agent function corresponding to the recognized wake-up word. In the example of FIG. 7, the agent wake-up determiner 114 activates the agent 1 (the agent function 150-1) whose wake-up word is “AAA” as a first agent in response to speech of the occupant P “Hi, AAA!.” After the activation, the agent function 150-1 causes the first display 22 to display an agent image EI1 under the control of the display controller 122.

FIG. 7 is a diagram showing an example of an image IM2 displayed by the display controller 122 in a situation where the first agent function is active. The image IM2 includes, for example, a text information display area A21 and an agent display area A22. For example, information on an agent that dialogues with the occupant P is displayed in the text information display area A21. In the example of FIG. 7, text information “Agent 1 is responding” is displayed in the text information display area A21. In this situation, the text information need not be displayed in the text information display area A21.

For example, an agent image associated with the agent that is dialoguing is displayed in the agent display area A22. In the example of FIG. 7, the agent image EI1 associated with the agent function 150-1 is displayed in the agent display area A22. This allows the occupant P to easily determine that the agent 1 has been activated.

Next, if the occupant P speaks “Where is a popular store these days?,” the agent function 150-1 performs voice recognition based on the content of the speech. Then, upon acquiring a voice recognition result, the agent function 150-1 generates a response result (a response sentence) based on the voice recognition result and outputs the generated response result to the occupant P for confirmation.

In the example of FIG. 7, the voice controller 124 generates a voice “Searching for a popular store these days!” in association with the response sentence generated by the agent 1 (the agent function 150-1 and the agent server 200-1) and causes the speaker unit 30 to output the generated voice. The voice controller 124 performs a sound image localization process of localizing the voice of the response sentence described above near a display position of the agent image EI1 in the agent display area A22. When the voice is output, the display controller 122 may generate and display an animation image or the like that allows the occupant P to visually recognize the agent image EI1 as if it speaks in tune with the output of the voice. The display controller 122 may also cause the response sentence to be displayed in the agent display area A22. This allows the occupant P to more accurately determine whether or not the agent 1 has recognized the content of the speech.

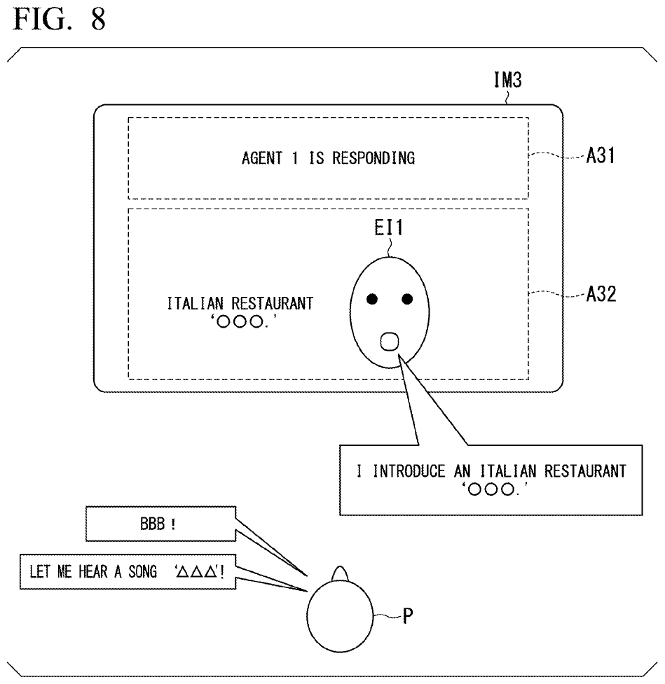

Next, the agent function 150-1 executes processing based on the content of the voice recognition and causes the output controller 120 to output a response result obtained through processing of the agent server 200-1 or the like. FIG. 8 is a diagram showing an example of how a response result is output. The example of FIG. 8 shows an image IM3 displayed on the first display 22. The image IM3 includes, for example, a text information display area A31 and an agent display area A32. Information on the agent 1 which is dialoguing is displayed in the text information display area A31 as in the text information display area A21.

For example, an agent image which is dialoguing and a response result from the agent are displayed in the agent display area A32. In the example of FIG. 8, the agent image EI1 and text information “Italian restaurant ‘◯◯◯’” which is the response result from the agent 1 are displayed in the agent display area A32. In this situation, the voice controller 124 generates a voice of the response result obtained by the agent function 150-1 and performs a sound image localization process of localizing the voice near the display position of the agent image EI1. In the example of FIG. 8, the voice controller 124 outputs a voice “I introduce an Italian restaurant ‘◯◯◯’.”

Here, it is assumed that the audio processor 112 has received speech of the occupant P “BBB! Let me hear a song ‘Δ Δ Δ’!” while the agent 1 is active. In this case, the other-agent wake-up determiner 152-1 compares text information “BBB” with wake-up words of other agents included in the agent control information 172 and determines that the text information “BBB” corresponds to the wake-up word for the agent 2.

The other-agent activation controller 154-1 activates the agent function 150-2 (another agent function) upon determining that the text information “BBB” corresponds to the wake-up word for the agent 2 from the determination result of the other-agent wake-up determiner 152-1. In this case, the other-agent activation controller 154-1 may output an instruction to activate the agent function 150-2 directly to the agent function 150-2 or may output an instruction to activate the agent function 150-2 to an agent wake-up determiner 114 associated with the agent function 150-2 such that the agent wake-up determiner 114 outputs the instruction to the agent function 150-2.

The other-agent activation controller 154-1 may also cause the voice controller 124 to generate a voice of its own agent corresponding to the wake-up word “BBB” to active the agent function 150-2 and cause the speaker unit 30 to output the generated voice. Thus, the voice corresponding to “BBB” input through the microphone 10 can be received by the audio processor 112 and the agent function 150-2 can be activated by the agent wake-up determiner 114.

Note that the agent device 100 may perform control such that not all agent functions can activate other agent functions, but only some of the agent functions can activate other agent functions. In this case, the other-agent activation controller 154-1 refers to the activation-controllable agent identification information included in the agent control information 172 and determines whether or not its own agent (agent 1) is an agent capable of controlling activation of another agent (agent 2). In the example of FIG. 4, the agent 1 is an agent capable of controlling activation of the agent 2. Thus, the agent function 150-1 activates the agent function 150-2.

Performing control such that only some of the agent functions can activate other agent functions as described above makes it possible to set different authorities for agents and to establish a master-slave (master-subagent) relationship between agents. It is preferable that the agent acting as the master (master) include the agent (for example, the agent function 150-1) that controls the vehicle equipment 50 and the like. Thus, for example, an agent that is expected to be active in the vehicle for a longer time than other agents or an agent having a higher degree of importance can immediately activate other agents.

The other-agent activation controller 154-1 may perform control to stop its own agent 1 (the agent function 150-1) after activating another agent (for example, the agent function 150-2). In this case, the other-agent activation controller 154-1 may directly perform control to stop the agent 1 or may output an end word “XXX” of the agent 1 acquired from the agent control information 172 to the agent wake-up determiner 114 such that the agent wake-up determiner 114 ends the agent 1.

The other-agent activation controller 154-1 may cause the voice controller 124 to generate a voice corresponding to the end word “XXX” of the agent 1 and cause the speaker unit 30 to output the generated voice. Thus, the voice corresponding to “XXX” input through the microphone 10 can be received by the audio processor 112 and the agent function 150-1 can be stopped by the agent wake-up determiner 114. After the agent 1 stops, the agent 2 of the other agent function (the agent function 150-2) responds to the speech of the occupant P.

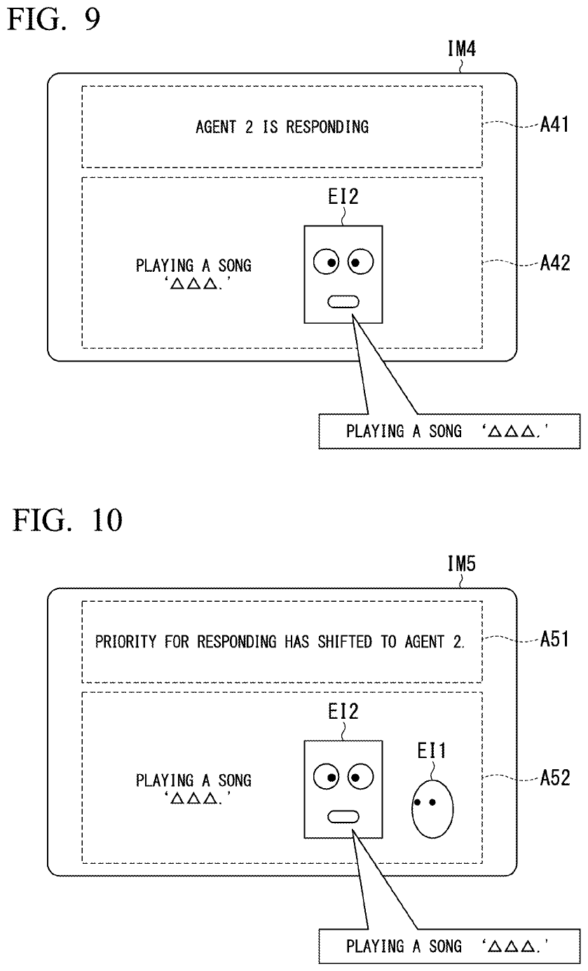

FIG. 9 is a diagram illustrating how the other agent function outputs a response result. The example of FIG. 9 shows an image IM4 displayed on the first display 22. The image IM4 includes, for example, a text information display area A41 and an agent display area A42. Information on the currently responding agent is displayed in the text information display area A41. In the example of FIG. 9, text information “Agent 2 is responding” is displayed in the text information display area A41.

For example, an agent image that is responding and a response result from the agent are displayed in the agent display area A42. The display controller 122 acquires, from the agent function 150-1, the response result and identification information of the other agent function that has generated the response result and generates an image to be displayed in the agent display area A42 on the basis of the acquired information.

In the example of FIG. 9, the agent image EI2 and text information “Playing a song ‘Δ Δ Δ’” which is the response result from the agent 2 are displayed in the agent display area A42. In this situation, the voice controller 124 generates a voice corresponding to the response result and performs a sound image localization process of localizing the voice near the display position of the agent image EI2. Further, the voice controller 124 causes the speaker unit 30 to output the song “Δ Δ Δ” included in the response result.

In this manner, the occupant P can stop the active agent and activate the other agent by speaking only a voice for activating the other agent without issuing an instruction to stop the active agent. Thus, it is possible to reduce the trouble of switching agents and improve the convenience for the occupant regarding the use of agents.

### Modifications

After activating the other agent, the other-agent activation controller 154 may perform control to give the other agent priority for responding to the speech of the occupant P while keeping its own agent active, instead of stopping its own agent. “Giving the other agent priority for responding to the speech of the occupant P” means, for example, to shift the priority for responding to the occupant P from an already activated agent to another agent that has been newly activated. In the case of the above example, the agent 1 and the agent 2 are active, but the agent 2 dialogues with the occupant P.

The agent 1 may receive a voice from the occupant P or a voice from the agent 2 even while the agent 2 is dialoguing with the occupant P and generate a response based on the meaning of the input voice. In this case, the agent 1 outputs the generated response result only upon issuance of an instruction from the agent 2 or an instruction from the occupant P. This allows the agent 1 to output a response result with a behavior like assisting the response of the agent 2.

The output controller 120 may cause the output to output information indicating that the agent 2 has been activated and the priority has been shifted from the agent 1 to the agent 2. FIG. 10 is a diagram illustrating information output when the priority for responding has been shifted. The example of FIG. 10 shows an image IM5 displayed on the first display 22. The image IM5 includes, for example, a text information display area A51 and an agent display area A52. Information indicating that the agent responding to the speech of the occupant P has been shifted is displayed in the text information display area A51. In the example of FIG. 10, text information “Priority for responding has been shifted to agent 2” is displayed in the text information display area A51.

For example, an agent image which is dialoguing and a response result from the agent are displayed in the agent display area A52 while an agent image from which the priority has been shifted is also displayed. In the example of FIG. 10, the agent image EI1, in addition to the display content in the agent display area A42 shown in FIG. 9 described above, is displayed in the agent display area A52. In this situation, the display controller 122 causes the agent image EI1 of the agent 1 having no priority to be displayed smaller than the agent image EI2 of the agent 2 having the priority. This allows the occupant P to easily determine which agent is responding even when a plurality of agent images are displayed.

The display controller 122 may also cause the agent image EI1 to be displayed with its expression, face orientation, or the like changing even when the agent 2 is responding. In the example of FIG. 10, an image in the agent image EI1 facing the agent image EI2 is displayed in the agent display area A52. Changing the expression or face orientation of the agent image EI1 even when the agent 2 is responding in this manner allows the occupant P to intuitively determine that not only the agent 2 but also the agent 1 is active.

In a modification, when the agent 2 has completed responding, the other-agent activation controller 154-1 may perform control to return the priority to the original (return the priority to the agent 1). As a result, even if another agent is caused to temporarily respond, it is possible to smoothly return to the original agent. As a result, the convenience for the occupant can be improved.

### [Processing Flow]

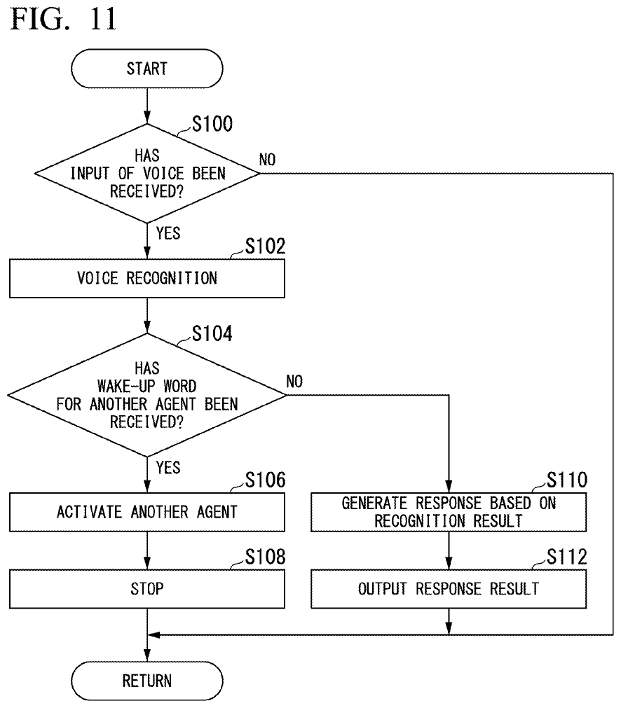

FIG. 11 is a flowchart illustrating an example of a flow of processing performed by the agent device 100 according to the first embodiment. Hereinafter, a description will be given of processing in the case where a first agent function (hereinafter referred to as the agent function 150-1 as an example) is already activated by the agent device 100. The processing of this flowchart may be repeatedly executed, for example, at predetermined periods or at predetermined timings.

First, the agent function 150-1 determines whether or not an input of a voice has been received from the audio processor 112 (step S100). Upon determining that an input of a voice has been received, the agent function 150-1 causes the recognizer to perform voice recognition on the input voice and acquires a voice recognition result (step S102). Next, the other-agent wake-up determiner 152-1 of the agent function 150-1 determines whether or not a wake-up word for another agent has been received (step S104).

Upon determining that a wake-up word for another agent has been received, the other-agent activation controller 154-1 activates an agent function corresponding to the other agent (step S106). The other-agent activation controller 154-1 stops its own agent that has been activated (step S108). Upon determining that a wake-up word for another agent has not been received in the process of step S104, the agent function 150-1 generates a response based on the recognition result (step S110) and outputs the generated response result (step S112). Then, the processing of this flowchart ends. Upon determining that an input of a voice has not been received in the process of step S100, the processing of this flowchart ends.

In the process of step S106, the other-agent activation controller 154-1 may determine whether or not the agent 1 has the authority to activate the other agent and may activate the other agent if the agent 1 has the authority to activate the other agent.

The agent device 100 according to the first embodiment described above includes the plurality of agent functions 150 which provide a service including a response in response to speech of an occupant of the vehicle M, and the other-agent activation controller 154 which activates another agent function upon issuance of an issuance to activate the other agent function while a first agent function is active among the plurality of agent functions 150, whereby it is possible to improve the convenience for the occupant in dialogue with agents.

### Second Embodiment

Hereinafter, a second embodiment will be described. An agent device according to the second embodiment differs from the agent device 100 according to the first embodiment in that a manager 110 includes an activation state manager 116 and an activation controller 118 instead of the other-agent wake-up determiners 152 and the other-agent activation controllers 154 in the agent functions 150. Thus, the following description will mainly focus on the activation state manager 116 and the activation controller 118 and the other components will be given the same terms and reference signs and the specific description thereof will be omitted.

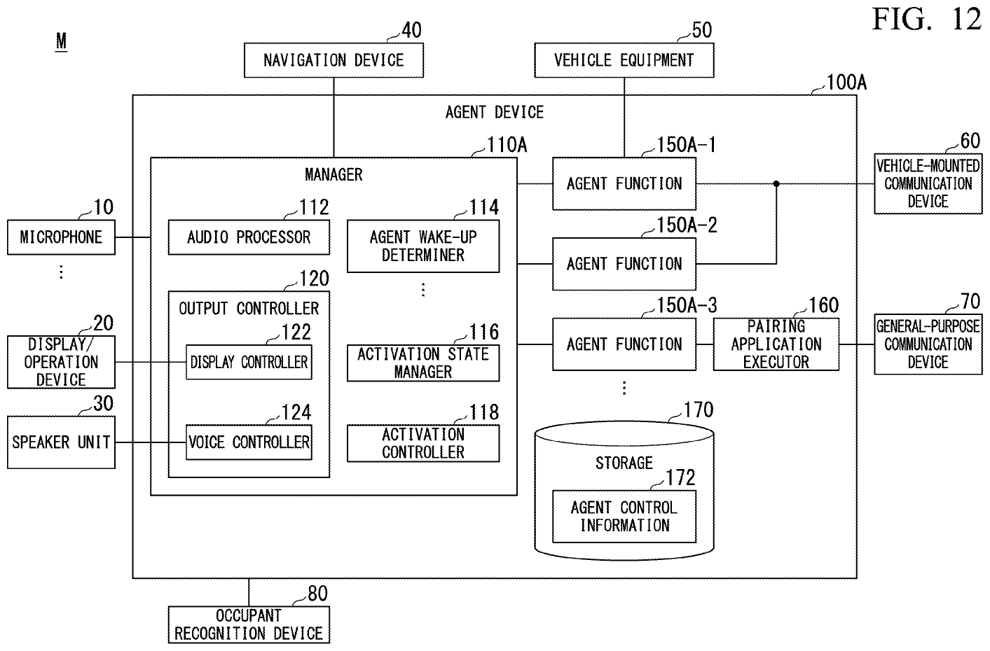

FIG. 12 is a diagram showing a configuration of an agent device 100A according to the second embodiment and devices mounted in a vehicle M. For example, one or more microphones 10, a display/operation device 20, a speaker unit 30, a navigation device 40, vehicle equipment 50, a vehicle-mounted communication device 60, an occupant recognition device 80, and the agent device 100A are mounted in the vehicle M. A general-purpose communication device 70 may sometimes be brought into an occupant compartment and used as a communication device. These devices are connected to each other through a multiplex communication line such as a CAN communication line, a serial communication line, or a wireless communication network.

The agent device 100A includes a manager 110A, agent functions 150A-1, 150A-2, and 150A-3, a pairing application executor 160, and a storage 170. The manager 110A includes, for example, an audio processor 112, agent wake-up determiners 114, the activation state manager 116, the activation controller 118, and an output controller 120. Each of the components of the agent device 110A is realized, for example, by a hardware processor such as a CPU executing a program (software). Some or all of these components may be realized by hardware (including circuitry) such as an LSI, an ASIC, an FPGA, or a GPU or may be realized by software and hardware in cooperation. The program may be stored in a storage device (a storage device having a non-transitory storage medium) such as an HDD or a flash memory in advance or may be stored in a detachable storage medium (non-transitory storage medium) such as a DVD or a CD-ROM and then installed by mounting the storage medium into a drive device.

Each agent function 150A has functions other than the other-agent wake-up determiner 152 and the other-agent activation controller 154 among the functions of the agent function 150 shown in the first embodiment.

The activation state manager 116 manages currently active agents. For example, the activation state manager 116 determines whether or not there are currently active agents when an agent wake-up determiner 114 has determined that text information of an input voice corresponds to a wake-up word for any agent. When there are active agents, the activation state manager 116 may acquire information on the agent type and the priority of each agent (as to which agent is responding to the speech of the occupant P).

If an agent wake-up determiner 114 determines that a wake-up word has been spoken and the currently active agents do not include an agent corresponding to the wake-up word, the activation controller 118 activates an agent corresponding to the wake-up word. In addition to performing this control, the activation controller 118 may refer to the activation-controllable agent identification information in the agent control information 172 and activate an agent corresponding to the wake-up word only when the currently active agent is an agent included in the activation-controllable agent identification information.

The activation controller 118 may perform control to stop an agent which is already activated, in addition to activating an agent corresponding to the wake-up word. In this case, the activation controller 118 may directly perform the control to stop the agent function 150A that is to be stopped. The activation controller 118 may also cause the voice controller 124 to generate a voice corresponding to an end word for an agent acquired from the agent control information 172 and cause the speaker unit 30 to output the generated voice. Thus, the voice corresponding to the end word input through the microphone 10 can be received by the audio processor 112 and the agent can be stopped by the agent wake-up determiner 114. The activation controller 118 may control to shift the priority for responding to the occupant's speech from the already active agent to the newly activated agent instead of stopping the already active agent.

### [Processing Flow]

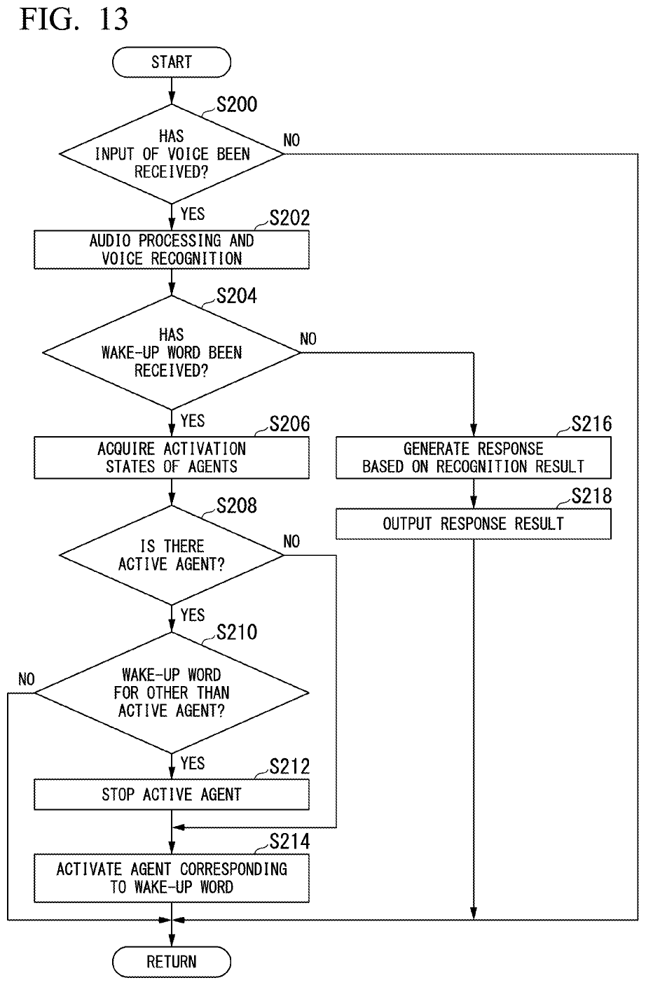

FIG. 13 is a flowchart illustrating an example of a flow of processing performed by the agent device 100A according to the second embodiment. The processing of this flowchart may be repeatedly executed, for example, at predetermined periods or at predetermined timings.

First, the manager 110A determines whether or not an input of a voice has been received from a microphone 10 (step S200). Upon determining that an input of a voice has been received, the manager 110A performs audio processing and voice recognition through an agent wake-up determiner 114 and acquires a voice recognition result (step S202). Next, the agent wake-up determiner 114 determines whether or not a wake-up word for an agent has been received by voice (step S204). Upon determining that a wake-up word has been received, the activation state manager 116 acquires activation states of agents (step S206).

Next, the activation controller 118 determines whether or not there is a currently active agent (step S208). Upon determining that there is a currently active agent, the activation controller 118 determines whether or not the received wake-up word is a wake-up word for other than the active agent (step S210). If the wake-up word is a wake-up word for other than the active agent, the activation controller 118 stops the active agent (step S212) and activates an agent corresponding to the wake-up word (step S214). Upon determining that there is no active agent in the process of step S208, the activation controller 118 activates an agent corresponding to the wake-up word (step S214).

Upon determining that a wake-up word for an agent has not been received in the process of step S204, the manager 110A or the active agent function 150A generates a response based on the recognition result (step S216) and outputs the generated response result (step S218). Then, the processing of this flowchart ends. Upon determining that an input of a voice has not been received in the process of step S200 or upon determining in the process of step S210 that the received wake-up word is not a wake-up word for other than the active agent, the processing of this flowchart ends.

According to the agent device 100A of the second embodiment described above, the manager 110A can manage states of agents and perform activation and stop control of other agents based on activation states of agents in addition to achieving the same advantages as those of the agent device 100 of the first embodiment.

Each of the first and second embodiments described above may be combined with all or a part of the other embodiment. Some or all of the functions of the agent device 100 (100A) may be included in the agent server 200. Some or all of the functions of the agent server 200 may be included in the agent device 100. That is, distribution of the functions among the agent device 100 (100A) and the agent server 200 may be appropriately changed according to the components of each device, the scale of the agent server 200 or the agent system 1, or the like. Distribution of the functions among the agent device 100 (100A) and the agent server 200 may be set for each vehicle M.

Although the mode for carrying out the present invention has been described above by way of embodiments, the present invention is not limited to these embodiments at all and various modifications and substitutions may be made without departing from the spirit of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An agent device comprising:
a plurality of agent functions configured to provide a service including a response in response to speech of an occupant of a vehicle,
wherein a first agent function that is active among the plurality of agent functions is configured to activate another agent function upon receiving an instruction to activate the other agent function.

2. The agent device according to claim 1, wherein the first agent function is configured to activate the other agent function and stop the first agent function upon receiving an instruction to activate the other agent function while the first agent function is active.

3. The agent device according to claim 1, wherein the first agent function is configured to activate the other agent function and give the other agent function priority for responding to the speech of the occupant upon receiving an instruction to activate the other agent function while the first agent function is active.

4. The agent device according to claim 2, wherein a part of the plurality of agent functions is set as an agent function capable of activating the other agent function.

5. The agent device according to claim 4, wherein the part of the plurality of agent functions includes an agent function configured to control the vehicle.

6. The agent device according to claim 1, further comprising an activation controller configured to control activation of each of the plurality of agent functions,
wherein the activation controller is configured to stop the first agent function upon receiving an instruction to activate the other agent function.

7. The agent device according to claim 6, wherein the activation controller is configured to output an end word for ending the first agent function that is active.

8. An agent device control method comprising:
a computer activating some of a plurality of agent functions;
providing a service including a response in response to speech of an occupant of a vehicle through a function of the activated agent function; and
causing a first agent function that is active among the plurality of agent functions to activate another agent function upon receiving an instruction to activate the other agent function.

9. A non-transitory computer-readable storage medium storing a program causing a computer to:
activate some of a plurality of agent functions;
provide a service including a response in response to speech of an occupant of a vehicle through a function of the activated agent function; and
cause a first agent function that is active among the plurality of agent functions to activate another agent function upon receiving an instruction to activate the other agent function.
